(19) United States
(12) Patent Application Publication
(10) Pub. No.: US 2005/0245278 A1
(43) Pub. Date: Nov. 3, 2005

(54) Method and apparatus for forward link power control at non-serving radio sector transmitters

(76) Inventors: Rath Vannithamby, San Diego, CA (US); Shiau-He Shawn Tsai, San Diego, CA (US); Young C. Yoon, San Diego, CA (US); Anthony C.K. Soong, Superior, CO (US)

Correspondence Address: COATS & BENNETT, PLLC, P O BOX 5, RALEIGH, NC, 27602, US

(21) Appl. No.: 10/835,029

(22) Filed: Apr. 29, 2004

(51) Int. Cl. H04Q 7/20

(52) U.S. Cl. 455/522

(57) ABSTRACT

A method of allocating forward link transmit power with respect to a mobile station that actively is associated with a serving sector and one or more non-serving sectors of a wireless communication network comprises receiving channel quality information at the non-serving sectors as reported by the mobile station for the serving sector, and allocating forward link transmit power for the mobile station at the non-serving sectors as a function of the reported channel quality information. Non-serving sectors may assume that the reported channel quality information establishes the lower power allocation bound for the mobile station on the assumption that each of them has less favorable radio conditions than the serving sector with respect to the mobile station. Thus, base station transceivers operating as non-serving transmitters with respect to a given mobile terminal may nonetheless determine forward link transmit power allocations for the mobile station using serving sector channel quality information.

### BACKGROUND OF THE INVENTION

The present invention generally relates to wireless communication networks, and particularly relates to forward link transmit power control in such networks.

A typical wireless communication network uses feedback-based power control on both forward and reverse radio links. For example, a transmitting base station may be configured to increase or decrease the forward link transmit power allocated to a given mobile station based on signal quality information reported by the mobile station for the base station's forward link transmissions. In an exemplary embodiment of such power control, the base station dynamically increases and decreases the allocated forward link transmit power to maintain a targeted signal quality at the mobile station over changing radio conditions.

Oftentimes, more than one of the network's radio base stations will be close enough to the mobile station's current position to send and receive data from the mobile station with sufficient signal strength to achieve reasonably low error rates. In CDMA networks, it is common to receive reverse link transmissions from the mobile station at two or more radio sector transceivers, which may or may not be in the same radio base station. The advantage of such reception is that the mobile station's transmissions are considered successfully received if any one of the sector transceivers associated with a given base station controller correctly receives the data. Such multi-sector reception commonly is referred to as being in a soft handoff condition.

Soft handoff, wherein the network transmits to the mobile station from two or more radio sectors on the forward link may or may not be used. Indeed, it is common for the network to send forward link data (traffic) to the mobile station from a so called “serving” sector transmitter that is dynamically selected by the mobile station as the best one among a number of candidate sectors. Serving the mobile station from the transmitter that currently has the best radio conditions relative to the mobile station enhances network efficiency by allowing higher data rates and/or lower transmit power levels.

In picking a serving sector, the mobile station measures the received strengths of transmitter pilot signals and identifies a set of sector transmitters that are suitable candidates for serving the mobile station, i.e., radio sector transmitters network in the network whose transmitted signals are currently reaching the mobile station with sufficient strength to be considered as viable candidates for serving the mobile station on the forward link. Candidates are added and dropped to the set by the mobile station as the relative radio conditions change.

In some types of networks, the non-serving sectors typically also transmit to the mobile station on one or more forward link channels. For example, in Release D of IS-2000, the non-serving sectors may continue broadcasting reverse link rate control information to the mobile station on a forward link rate control channel (F-RCCH). Further, the non-serving sectors may provide the mobile station with ACK/NAK feedback for the mobile station's reverse link data transmissions. Such feedback is useful because if any one of the serving and non-serving sectors successfully received a given data transmission from the mobile station, retransmission is not necessary.

One challenge in managing the forward link transmissions to the mobile station from the non-serving radio sectors arises in the context of power control. That is, the mobile station provides power control feedback for the serving sector based on the radio conditions it determines relative to that serving sector. Thus, the channel quality information or other received signal strength feedback provided by the mobile station directly establishes transmit power targets for the serving sector but leaves the non-serving sectors without any mechanism for direct, feedback-based allocation of forward link transmit power for the mobile station.

### SUMMARY OF THE INVENTION

The present invention provides an apparatus and method for allocating forward link transmit power in non-serving sectors of a wireless communication network. At any given time, a given one of the one or more sectors in a particular mobile station's “active set” of supporting network sectors is designated as the serving sector. The radio base station transceiver in that serving sector controls the allocation of forward link transmit power for one or more forward link channel signals being transmitted by it to the mobile station based on channel quality information reported by the mobile station for the serving sector. According to the present invention, the non-serving sector transmitters in the active set also use this reported channel quality information to control their forward link transmit power allocations for the mobile station.

Thus, according to the present invention, an exemplary method of allocating forward link transmit power with respect to a mobile station that actively is associated with a serving sector and one or more non-serving sectors of a wireless communication network, comprises receiving channel quality information at the non-serving sectors as reported by the mobile station for the serving sector, and allocating forward link transmit power for the mobile station at the non-serving sectors as a function of the reported channel quality information. Such allocation may be based on assuming that the reported channel quality information establishes a lower bound for power allocation since it is assumed that the non-serving sectors have less favorable radio conditions than the currently designated serving sector relative to the mobile station.

In another exemplary embodiment, a method of controlling forward link transmit power for a mobile station in non-serving sectors of a wireless communication network currently included in the mobile station's active set comprises receiving channel quality information reported by the mobile station for a currently designated serving sector of the wireless communication network at each of one or more non-serving base station transceivers, and setting forward link transmit power for one or more forward link channels being transmitted from the non-serving base station transceivers to the mobile station based on the reported channel quality information. Again, the reported channel quality information may be used to establish the lower bounds for power allocation at the non-serving sector transmitters.

Complementing the above exemplary methods, an exemplary base station for use in a wireless communication network comprises a radio transceiver circuit configured to control forward link transmit power allocation when operating in a non-serving mode with respect to a given mobile station based on channel quality information as reported by that mobile station for a serving base station. The radio transceiver circuit(s) of the base station may be configured to set a lower bound for forward link transmit power allocation based on the reported channel quality information, so that when the transceiver circuits are operating in a non-serving mode with respect to the mobile station, the forward link transmit power allocation still is referenced to the channel quality information being reported by the mobile station for the serving sector. Preferably, the non-serving base station transceivers set their forward link transmit power allocations at least as high as the serving base station allocation. More preferably, they allocate forward link transmit power above the lower bound defined by the reported channel quality information on the presumption that their radio conditions relative to the mobile are worse than that reported for the serving sector.

Of course, the present invention is not limited to the above features and advantages. Those skilled in the art will recognize additional features and advantages of the present invention upon reading the following detailed description and upon viewing the accompanying figures, in which like elements are assigned like reference numbers.

### BRIEF DESCRIPTION OF THE DRAWINGS

FIG. 1 is a diagram of a wireless communication network configured in accordance with one or more embodiments of the present invention.

FIG. 2 is a diagram of exemplary details for a radio base station in the network of FIG. 1.

FIG. 3 is a diagram of exemplary radio base station processing circuits configured to carry out forward link transmit power control in accordance with one or more embodiments of the present invention.

FIG. 4 is a diagram of exemplary forward link transmit power control processing at a non-serving sector of the network of FIG. 1.

FIG. 5 is a diagram of exemplary processing details for setting non-serving sector forward link transmit power according to one embodiment of the invention.

### DETAILED DESCRIPTION OF THE INVENTION

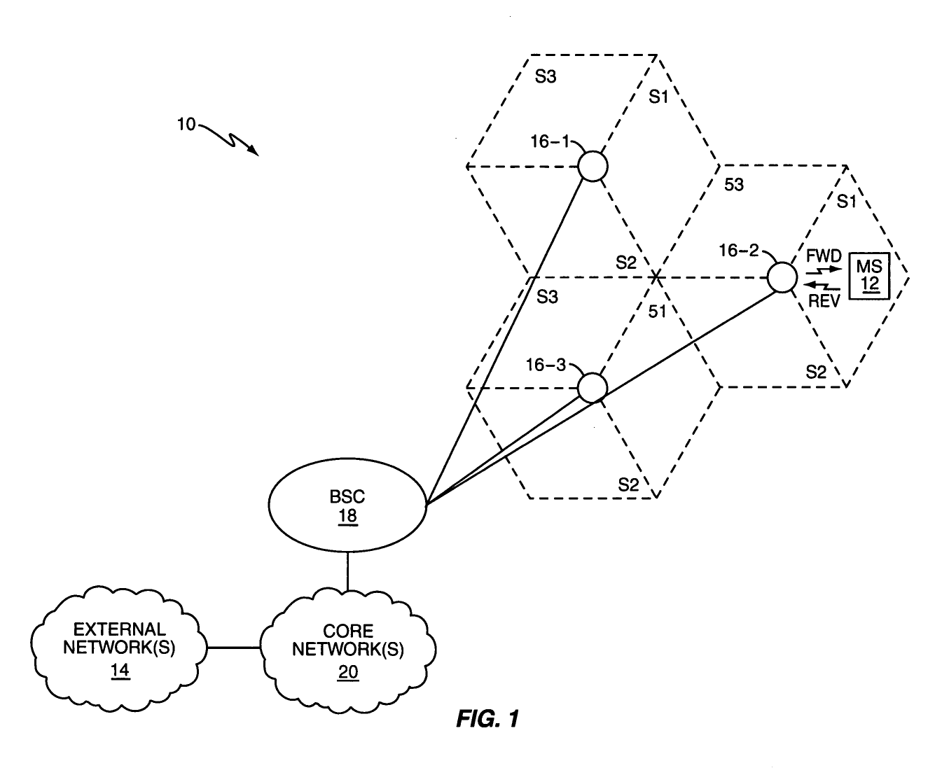

FIG. 1 is a diagram of an exemplary wireless communication network 10 operative to communicatively couple a mobile station 12 to one or more external networks 14, such as a Public Data Network (PDN), e.g., the Internet, or the Public Switched Telephone Network (PSTN). As illustrated, network 10 comprises a number of radio base stations 16 and an associated base station controller 18, and further comprises one or more Core Networks (CNs) 20, which may include a Packet Switched Core Network (PSCN) supporting packet data communications and may include a Circuit Switched Core Network (CSCN) supporting traditional circuit-switched voice and data applications.

While only one base station controller 18 and three radio base stations 16 are illustrated in network 10, such illustration is for simplicity of discussion and it should be understood that network 10 actually may include a plurality of base station controllers 18, each with any number of radio base stations 16. Indeed, those skilled in the art should appreciate that network 10 in actual implementation may include any number of entities not explicitly illustrated, such as Home Location Registers (HLRs), Visitor Location Registers (VLRs), Authentication/Accounting/Access (AAA) servers, etc.

Regardless, in operation, network 10 communicatively couples mobile station 12 to external network(s) 14 via a radio link supporting wireless communication between one or more radio base stations 16 and mobile station 12. The radio link, which comprises one or more forward link channels and one or more reverse link channels, is configured according to desired modulation formats and signaling protocols. For example, network 10 may be configured according to cdma2000 standards, Wideband CDMA (WCDMA) standards, etc.

In serving the mobile station 12 on the forward link, network 10 may transmit signals from each of one or more radio sectors. For example, in the illustration, network 10 may transmit to mobile station 12 from one or more sectors (S1, S2, and S3) of radio base station 16-1, 16-2, and 16-3. Similarly, network 10 may receive reverse link signals from the mobile station 12 via one or more sectors at each of one or more of its radio base stations 16. Soft handoff on the reverse link may be defined as network 10 receiving reverse link signals from the mobile station 12 in two or more sectors, each associated with a different one of the radio base stations 16. Further, one or more of the radio base stations 16 may be in softer handoff with the mobile station 12 on the reverse link, wherein two or more sectors of the same radio base station 16 are included in the mobile station's “active set.”

In exemplary operation, network 10 defines signal strength thresholds that are provided to the mobile station 12. In turn, mobile station 12 uses those signal strength thresholds to identify the sectors of network 10 to include in the mobile station's active set. As the radio conditions change during operation, the mobile station 12 changes its active set responsive to the changing signal strengths seen from the various sectors of each radio base station 16.

On the forward link, the mobile station 12 may or may not be served from multiple sectors at any given instant. For example, in an exemplary embodiment, network 10 is configured to transmit data to the mobile station 12 from a “serving” sector that is dynamically selected as the best one of the radio sectors available for transmitting data to the mobile station 12. That is, the sector transceiver of the radio base station 16 that can provide the mobile station 12 with the best quality signal at any given instant in time may be used to serve the mobile station 12. Of course, the serving sector changes with changing radio conditions and changing active set membership.

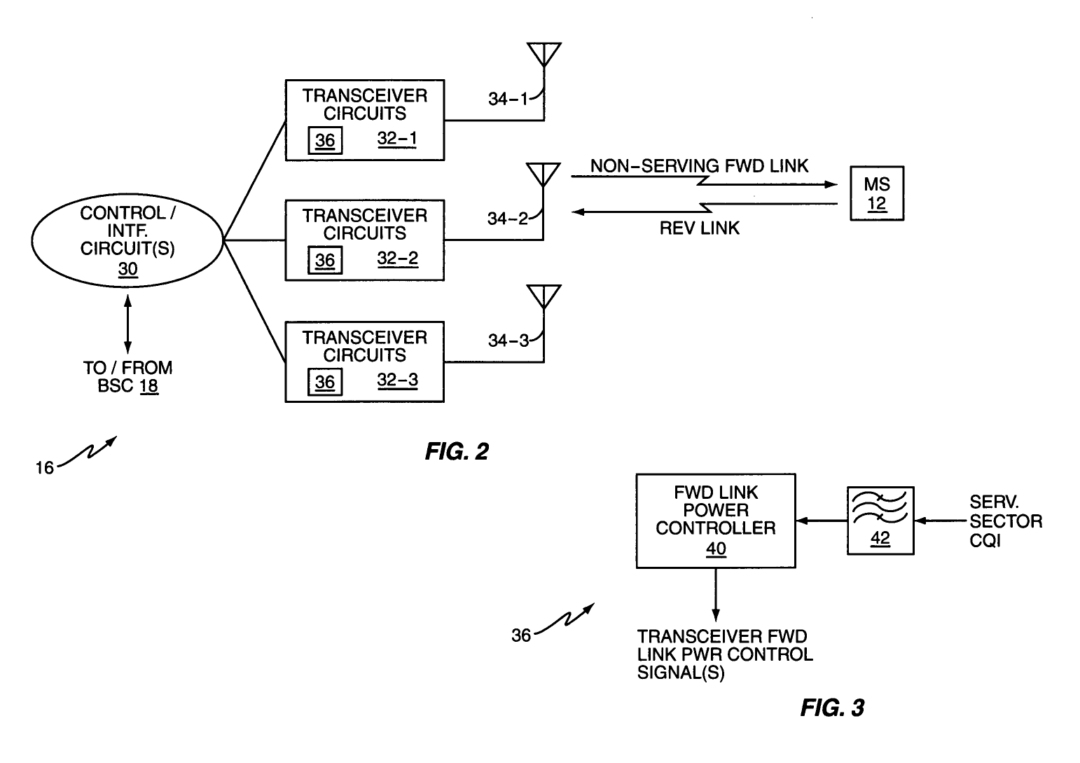

FIG. 2 illustrates an exemplary embodiment for any one of the radio base stations 16 comprising a control/interface circuit 30 that couples the radio base station 16 to the base station controller 18, and a radio sector transceiver circuit 32 and associated antenna assembly 34 for each radio sector of the radio base station 16, e.g., transceiver circuit 32-1 and antenna assembly 34-1, transceiver circuit 32-2 and antenna assembly 34-2, and so on. In the illustration, at least one of the radio base station's sector transceiver circuits 32 is operating as a non-serving sector transceiver with respect to mobile station 12, although it should be understood that the serving/non-serving status of individual sector transceivers change as a function of changing radio conditions.

In terms of allocating forward link transmit power to the mobile station 12 at a serving sector, the base stations 16 may be configured such that serving sector forward link transmit power is set explicitly as a function of received signal quality information returned from mobile station 12 for one or more of the serving sector's forward link signals as received at the mobile station 12. That is, the mobile station 12 may return a channel quality indicator (CQI) value that may represent a predefined received signal quality indicator, a measured signal strength, measured signal-to-interference-plus-noise ratio (SINR), etc. In turn, the serving sector radio base station 16 can use the returned CQI value to set a target pilot transmit power and then transmit one or more additional forward link channel signals, such as a traffic channel signal, to the mobile station 12 at some transmit power set relative to the pilot power.

However, the returned CQI values indicate received signal quality at the mobile station 12 only for signals from the current serving sector. Therefore, if forward link signals are being transmitted to the mobile station 12 from one more non-serving sectors, there is no direct feedback from mobile station 12 that may be used to allocate forward link transmit power for the transmission of such signals. In an exemplary embodiment, network 10 transmits one or more forward link control channel signals from serving sector radio base stations 16 and non-serving sector radio base stations 16.

For example, network 10 is configured according to Release D of the IS-2000 standards in at least one embodiment, wherein forward link rate control channel signals (F-RCCH) are transmitted to the mobile station 12 from serving and non-serving sectors and/or forward link acknowledgement channel signals (F-ACKCH) are transmitted to the mobile station from serving and non-serving sectors.

Regardless of the particular channels transmitted to mobile station 12 from the non-serving sectors, if the non-serving sector forward link transmit power is allocated at too high a level, the finite forward link power resources at each non-serving transceiver circuit 32 are needlessly wasted and overall system interference is increased. Conversely, if the non-serving sector forward link transmit power is set too low, the mobile station 12 will not be able to reliably receive such transmissions. Missing some types of commands may be more critical than missing other types of commands. For example, missing an acknowledgment channel command, i.e., an ACK or NAK acknowledgment for a prior mobile station data transmission may cause the mobile station 12 to erroneously retry transmission of the same data. Such erroneous retries can greatly reduce the effective reverse link data rate and represent system inefficiency. Thus, non-serving sectors may set forward link transmit power based on the CQI reported for the serving sector and further based on a channel/command priority scheme.

More generally, the present invention provides a method and apparatus whereby non-serving sector radio base stations 16 can intelligently control the forward link transmit power allocation for the mobile station 12 based on the channel quality information reported by the mobile station 12, even though that reported information is intended for power control at the serving sector rather than at the non-serving sectors. FIG. 2 indicated that each radio sector transceiver circuit 32 may be configured to include one or more processing circuits 36. These processing circuits may be configured to provide forward link transmit power control functions at least for non-serving sector operation and, preferably, also for serving sector operation.

FIG. 3 illustrates exemplary processor circuit details for the one or more processing circuits 36, wherein processing circuits 36 comprise a power controller 40 and, optionally, a filtering circuit 42 to filter channel quality information reported by the mobile station 12. Processing circuits 36 may comprise hardware, software, or any combination thereof, and are configured to carry out non-serving sector forward link transmit power control based on channel quality information reported by the mobile station 12 for the serving sector. Of course, it should be understood that a given transceiver circuit 32 may be operating as a non-serving sector transceiver at one time, and operating as a serving sector transceiver at another time in dependence on changing radio conditions. Indeed, once a sector is dropped from the mobile station's active set, the associated transceiver circuit 32 typically does not transmit to the mobile station in any capacity.

In any case, controller 40, which may be implemented as one or more digital processing circuits, e.g., microprocessors, microcontrollers, DSPs, ASICs, FPGAs, or other type of digital processing circuit, receives or otherwise has access to the channel quality information reported by mobile station 12 for the currently designated serving sector. In an exemplary embodiment, CQI values are received from the mobile station 12 on the reverse link at the serving and the non-serving sectors. Controller 40 may operate on a smoothed CQI value rather than on the individual CQI values reported by the mobile station 12. Optional filter circuit 42 may be configured to apply a desired filter function to the incoming CQI values, e.g., simple averaging, exponential weighting, etc.

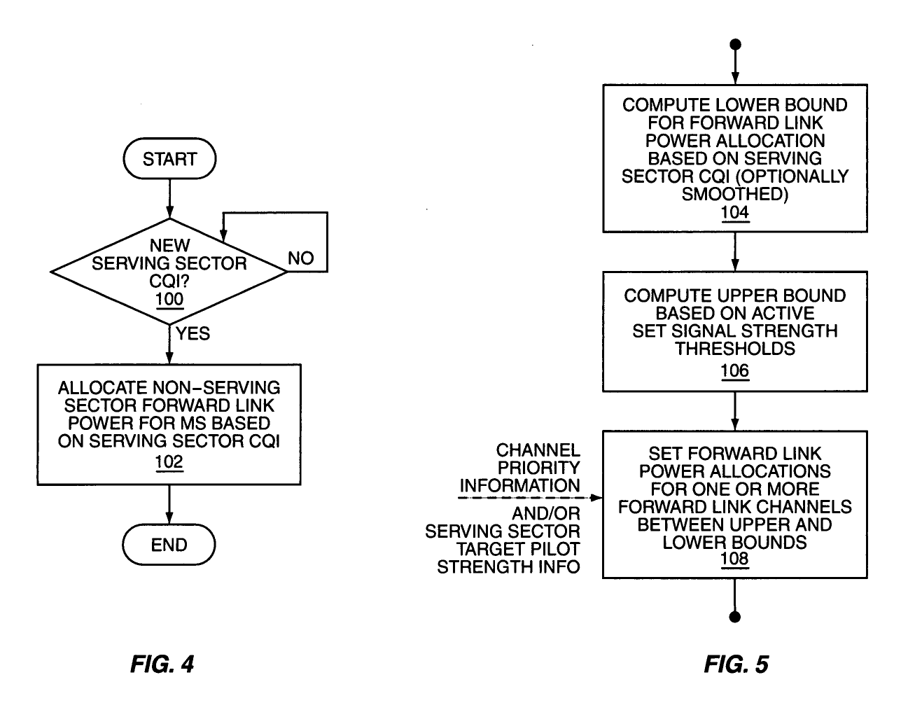

FIG. 4 broadly illustrates non-serving sector forward link transmit power control, wherein processing begins with controller 40 waiting for an incoming or otherwise updated CQI value (Step 100). CQI values may be reported by the mobile station 12 on a periodic basis, such as at the rate of every ten milliseconds. Of course, the particulars regarding CQI reporting will vary as a function of the network standards and such details should not be considered as limiting the present invention.

Regardless, if updated channel quality information is available, controller 40 determines the appropriate allocation of forward link transmit power based on that reported channel quality information, even though such information is intended for the serving sector rather than for the non-serving sectors. FIG. 5 illustrates one embodiment for setting non-serving forward link transmit power as a function of serving sector COI.

In FIG. 5, controller 40 computes a lower bound for the non-serving sector forward link transmit power allocation based on the reported serving sector CQI (Step 104). Using the reported CQI as a mechanism to find the lower bound for non-serving forward link transmit power is based on the presumption that the non-serving sector has poorer radio conditions than the serving sector with respect to the mobile station 12. Controller 40 then computes an upper bound for the non-serving sector forward link transmit power based on, for example, the signal strength threshold(s) used by mobile station 12 to determine which radio base stations 16 are included in its active set (Step 106).

Controller 40 then generates one or more power control signals, which may be digital and/or analog in format, to set the forward link transmit power allocation for one or more of the forward link signals being transmitted to mobile station 12 from its associated transceiver circuit 32 (Step 108). The control signals may be used to control particular transmitter elements in transceiver circuits 32 to effect the desired power control.

The power control signal(s) may be calculated to set the forward link transmit power allocation to a value between the upper and lower bound. In one embodiment, the reported CQI is used to determine the lower power bound, the active set signal strength threshold(s) are used to determine the upper bound, and controller 40 determines the forward link transmit power allocation as a mid-point value between those two bounds. Alternatively, controller 40 may apply a “margin” to the lower bound to arrive at a calculated forward link transmit power allocation. For example, controller 40 may calculate the lower bound based on the serving sector CQI and then set the non-serving sector power some percentage higher than that value, e.g., 20% higher.

To that end, if a non-serving sector is associated with the same radio base station 16 as the serving sector, i.e., a softer handoff condition involving a non-serving transceiver circuit 32 and a serving transceiver circuit 32, then the non-serving sector transceiver circuit 32 will have convenient access to the serving sector's target pilot strength power, which is computed at the serving sector transceiver circuit 32 directly from the reported CQI. Also, even without softer handoff conditions, the serving radio base station 16 can be configured to report target pilot strength information for the mobile station 12 to the base station controller 18, which can then disseminate such information to each of the non-serving sector radio base stations 16.

Further, it should be noted that each non-serving sector may transmit different types of forward link channel signals to the mobile station 12, and that these channels may have differing priorities. For example, as alluded to earlier herein, the consequences of transmitting ACK/NAK channel signals at a too-low power from the non-serving sectors may cause needless data retransmissions by the mobile station 12. Further, if the mobile station 12 is unable to properly receive reverse link rate control commands on the F-RCCH signals being transmitted from one or more of the non-serving sectors, it may not be fully responsive to the network's attempts to move mobile station data rates up and down as needed to effect overall load control.

In such cases, it may make sense to determine a lower bound for the forward link transmit power at each non-serving sector, and then to transmit one or more of the forward link transmit channel signals at power levels determined from that lower bound and from a channel priority scheme. For example, the more critical channels, or the more critical command types for a given channel, could be transmitted at higher power margins relative to the lower bound than would be used for the less critical channels, or for the less critical commands.

As an example of command prioritization, the present invention provides for different transmit power levels subject to the “importance” of the particular command being sent on a given forward link channel. For example, in terms of reverse link rate control, a “DOWN” command is of more value than an “UP” command for network stability and operation. Based on this, certain types of commands on one or more forward link channels may be transmitted from non-serving sectors at higher powers relative to the lower power bound than used for less critical commands.

With the above implementation flexibility in mind, the discussion turns to a more detailed numerical example of exemplary non-serving sector forward link transmit power control. Assume that the serving sector pilot channel-to-interference (C/I) ratio at the mobile station 12 is −8 dB, and further assume that the pilot C/I at the mobile station 12 is −10 dB for a given non-serving sector. If the processing gain is 128=21 dB for the F-RCCH, then for 0 dB RCCH/Pilot ratio, the RCCH received symbol SNR will be (−8 dB+0 dB+21 dB)=13 dB for the serving sector, and (−10 dB+0 dB+21 dB)=11 dB for the non-serving sector.

If the required symbol SNR is 7 dB, then ideally the RCCH/Pilot ratio should be adjusted to −6 dB at the serving sector and to −4 dB at the non-serving sector. However, the non-serving sector does not know its pilot C/I received at the mobile is −10 dB because the CQI reports from the mobile station 12 express only the quality of the serving sector's pilot signal as received at the mobile station 12. However, the non-serving sector does know that its pilot C/I as seen by mobile station 12 is at least above the threshold used to admit radio base stations into the mobile station's active set. That is, because the non-serving sector radio base station 16 is a current member of the mobile station's active set, the non-serving sector radio base 16 at least knows that the mobile station 12 is receiving the non-serving sector pilot signal at or above the active set signal strength threshold. The threshold at which the mobile station 12 adds a radio base station 16 to its active set may be expressed as T_ADD, and an exemplary value for T_ADD=−14 dB.

Thus, for a margin of safety, a non-serving sector could simply set the forward link transmit power allocation for one or more of the channels it is transmitting to the mobile station 12 at the T_ADD level. For a sector that is switched from a serving status to a non-serving status, forward link transmit power allocation initially could be based on the last CQI value reported during its status as the serving sector, or based on some filtered value of CQIs reported during its time as the serving sector. Then, after becoming a non-serving sector, the corresponding controller 40 could gradually ramp the forward link transmit power allocation from the lower bound established by that prior channel quality information up toward the upper bound established by the T_ADD threshold.

Thus, a serving sector transceiver 32 circuit will set one or more of its forward link channel power allocations based on some ratio relative to the sector's pilot power, which is determined directly from the CQI reported for the serving sector, e.g., to set the F-RCCH/pilot power ratio. Then, if the status of that sector switches to non-serving, the transceiver circuit 32 could begin ramping forward link transmit power toward the T_ADD upper bound, or to some point at or above the lower bound as calculated from the current CQI according to any of the above methods.

With the above variations in mind, those skilled in the art will appreciate that the present invention broadly provides a mechanism for a radio base station 16 to set the forward link transmit power of an included non-serving sector transceiver circuit 32 based on the channel quality information reported by the mobile station 12 for a serving sector transceiver circuit 32 that may or may not be included in the same radio base station 16. In an exemplary embodiment, the lower bound of the non-serving sector forward link transmit power control range is estimated from the reported CQI value. If desired, an upper bound for the non-serving sector forward link transmit power control range can be set based on an active set signal strength threshold. The non-serving radio base station 16 thus can set the transmit power of one or more forward link channel signals intended for the mobile station 12 based on such control.

As detailed above, one embodiment of the forward link transmit power allocation method is to set the transmit power level to the average of the lower and upper bounds. In another embodiment, the non-serving radio base station 16 sets its forward link transmit power level between the lower and upper bounds based on a specified parameter. The parameter can be tuned based on field trials, sector loading conditions, etc. Further, the parameter may be determined as a scaling metric, wherein the non-serving radio base station 16 uses the channel quality information reported for the serving sector to determine a forward link transmit power setting, and then scales that setting by the metric.

For example, as noted earlier herein, the non-serving radio base station 16 may have access to target pilot signal strength information for the serving sector, or otherwise may have access to information that can be used to express the relative radio conditions of the non-serving and serving sectors. With that information, a non-serving transceiver circuit 32 can calculate how much higher its forward link transmit power needs to be to achieve the desired signal strength at the mobile station 12.

In another embodiment, power control can be based on tracking how many times the rate control commands sent by the non-serving sector are violated by the mobile station 12. For example, the number of times the mobile station 12 incorrectly responds to rate control commands transmitted from a non-serving transceiver circuit 32 can be used as an indication of whether the forward link transmit power is too low at that transceiver circuit 32. Even with such embodiments, the upper and lower bounds for non-serving sector forward link transmit power control described above may be used to limit the power control range.

Therefore, the present invention should be understood as not being dependent on particular radio base station hardware and software, or on a particular embodiment of non-serving sector forward link transmit power control. Rather, the present invention broadly encompasses the use of channel quality information reported by a mobile station for a serving radio base station sector transmitter to set the forward link transmit power of one or more non-serving sector radio transmitters. As such, the present invention is not limited by the foregoing discussion but rather is limited only by the following claims and their reasonable equivalents.

1. A method of allocating forward link transmit power with respect to a mobile station that actively is associated with a serving sector and one or more non-serving sectors of a wireless communication network, the method comprising:
receiving channel quality information at the non-serving sectors as reported by the mobile station for the serving sector; and
allocating forward link transmit power for the mobile station at the non-serving sectors as a function of the reported channel quality information.

2. The method of claim 1, wherein allocating power at the non-serving sectors as a function of the reported channel quality information comprises setting a lower bound for forward link transmit power allocation with respect to the mobile station based on the reported channel quality information, and allocating forward link transmit power for one or more forward link channels intended for the mobile station at or above that lower bound.

3. The method of claim 2, wherein allocating forward link transmit power for one or more forward link channels intended for the mobile station at or above that lower bound comprises allocating forward link transmit power based on adding a defined power margin to the lower bound.

4. The method of claim 2, wherein allocating forward link transmit power for one or more forward link channels intended for the mobile station at or above that lower bound comprises allocating forward link transmit power based on selecting a transmit power level between the lower bound and an upper bound associated with received signal level settings used to determine an active set of sectors for the mobile station.

5. The method of claim 1, wherein allocating forward link transmit power for the mobile station at the non-serving sectors as a function of the reported channel quality information comprises allocating forward link transmit power for one or more forward link channels in each non-serving sector based on the reported channel quality information.

6. The method of claim 5, wherein allocating forward link transmit power for one or more forward link channels in each non-serving sector based on the reported channel quality information comprises determining a power allocation for one or more of a forward link rate control channel, a forward link acknowledgement channel, and a forward link transmit power control channel.

7. The method of claim 1, wherein allocating forward link transmit power for the mobile station at the non-serving sectors as a function of the reported channel quality information comprises filtering the reported channel quality information to obtain a smoothed channel quality value and, in each non-serving sector, allocating forward link transmit power for the mobile station based on the smoothed channel quality value.

8. The method of claim 1, wherein mobile station is in softer handoff with one or more of the non-serving sectors and wherein, for those non-serving sectors, allocating forward link transmit power for the non-serving sectors as a function of the reported channel quality information further comprises allocating forward link transmit power for the mobile station based on the reported channel quality information and based on a target channel quality of the serving sector's pilot signal.

9. The method of claim 1, further comprising at each of one or more of the non-serving sectors, receiving target reported channel quality information for a pilot signal of the serving sector, determining a metric that relates expected signal qualities of the non-serving and serving sectors, and allocating forward link transmit power in the non-serving sector based on the reported channel quality information and the metric.

10. The method of claim 1, wherein allocating forward link transmit power for the mobile station at the non-serving sectors as a function of the reported channel quality information comprises, at each non-serving sector, setting a transmit power for each of one or more forward link channels intended for the mobile station based on a channel priority and based on the reported channel quality information.

11. The method of claim 1, wherein allocating forward link transmit power for the mobile station at the non-serving sectors as a function of the reported channel quality information comprises, at each non-serving sector, setting a transmit power for at least one forward link channel intended for the mobile station based on the reported channel quality information, and based on one or more command priorities associated with different commands to be transmitted on the forward link channel.

12. The method of claim 1, wherein allocating forward link transmit power for the mobile station at the non-serving sectors as a function of the reported channel quality information comprises, at each non-serving sector, controlling the forward link transmit power of a forward link channel on which commands are being transmitted to the mobile station as a function of the reported channel quality information and one or more command priorities associated with the particular commands being transmitted on the forward link channel.

13. The method of claim 12, wherein the commands being transmitted to the mobile station comprise rate control commands selectively directing the mobile station to increase or decrease its reverse link transmit rate, and further comprising assigning a higher priority to down rate control commands as compared to up rate control commands, such that down rate control commands are transmitted to the mobile station at a higher power than are up rate control commands for the same reported channel quality information.

14. A base station for use in a wireless communication network comprising a radio transceiver circuit configured to control forward link transmit power allocation when operating in a non-serving mode with respect to a given mobile station based on channel quality information as reported by that mobile station for a serving base station.

15. The base station of claim 14, wherein the radio transceiver circuit is configured to set a lower bound for forward link transmit power allocation based on the reported channel quality information.

16. The base station of claim 14, wherein the radio transceiver circuit is configured to set the forward link transmit power allocation to a value between a lower bound established by the reported channel quality information and an upper bound established by an active set signal strength value defined for use by the mobile station to identify active set candidate base stations.

17. The base station of claim 14, wherein the radio transceiver circuit is configured to allocate forward link transmit power to each of one or more forward link channel signals intended for the mobile station based on the reported channel quality information and on a channel priority scheme.

18. The base station of claim 17, wherein the radio transceiver circuit is configured to set a lower bound for allocating forward link transmit power to each forward link channel signal based on the reported channel quality information, and further configured to set the forward power allocation for the forward link channel signal at or above that lower bound as a function of the channel priority scheme, such that higher priority channels are allocated relatively higher powers than are lower priority channels.

19. The base station of claim 14, wherein the radio transceiver circuit is configured to use pilot signal target information associated with another radio transceiver in the network that is operating as a serving transceiver for the mobile station to calculate a scaling metric, and to set the forward link transmit power allocation for the mobile station based on applying that scaling metric to a lower power bound set by the reported channel quality information.

20. The base station of claim 14, wherein the radio transceiver circuit is configured to control forward link transmit power allocation when operating in a non-serving mode with respect to a given mobile station based on the channel quality information as reported by that mobile station for the serving base station, and further based on one or more command priorities associated with commands being sent from the base station to the mobile station.

21. The base station of claim 14, wherein the radio transceiver circuit is configured to control forward link transmit power allocation when operating in a non-serving mode with respect to a given mobile station based on the channel quality information as reported by that mobile station for the serving base station, and further based on one or more channel priorities associated with one or more forward link channel signals being transmitted from the base station to the mobile station.

22. A method of controlling forward link transmit power for a mobile station in non-serving sectors of a wireless communication network currently included in the mobile station's active set, the method comprising:
receiving channel quality information reported by the mobile station for a currently designated serving sector of the wireless communication network at each of one or more non-serving base station transceivers;
setting a forward link transmit power for one or more forward link channels being transmitted from non-serving base station transceivers to the mobile station based on the reported channel quality information.

23. The method of claim 22, wherein each non-serving base station transceiver calculates a lower bound for allocating forward link transmit power to the mobile station based on the reported channel quality information.

24. The method of claim 23, wherein each non-serving base station transceiver calculates an upper bound for allocating forward link transmit power to the mobile station based on a signal strength threshold used by the mobile station to determine its active set of base station transceivers, and wherein each non-serving base station transceiver sets the forward link transmit power allocation for the mobile station to a value between the upper and lower bounds.

25. The method of claim 22, wherein each non-serving base station transceiver that is in softer handoff with the mobile station relative to the currently designated serving sector uses pilot signal target information for the serving sector to calculate a scaling metric relating radio conditions of the non-serving base station transceiver to those of the serving base station transceiver, and allocates forward link transmit power for the mobile station based on applying the scaling metric to a lower power bound determined from the reported channel quality information.

26. The method of claim 22, further comprising setting the forward link transmit power for one or more forward link channels being transmitted from the non-serving base station transceivers to the mobile station additionally based on different command priorities associated with different commands being transmitted to the mobile station.

27. The method of claim 22, further comprising setting the forward link transmit power for one or more forward link channels being transmitted from the non-serving base station transceivers to the mobile station additionally based on different channel priorities associated with different forward link transmit channels being transmitted to the mobile station.
